(19) United States
(12) Patent Application Publication
(10) Pub. No.: US 2022/0053147 A1
(43) Pub. Date: Feb. 17, 2022

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventor: Haruko KAWANO, Kanagawa (JP)

(73) Assignee: FUJIFILM BUSINESS INNOVATION CORP., Tokyo (JP)

(21) Appl. No.: 17/147,597

(22) Filed: Jan. 13, 2021

(30) Foreign Application Priority Data
Aug. 14, 2020 (JP) 2020-137032

(51) Int. Cl. H04N 5/272; H04N 7/15; G06T 11/00

(52) U.S. Cl. CPC H04N 5/272; G06T 11/001; H04N 7/15

(57) ABSTRACT

An information processing device includes: a memory; and a processor configured to, when a captured image to be transmitted includes an object that is not wanted to be included in transmitting the image to an external device, execute image processing such that an image of the object is not displayed.

### CROSS-REFERENCE TO RELATED APPLICATIONS

This application is based on and claims priority under 35 USC 119 from Japanese Patent Application No. 2020-137032 filed Aug. 14, 2020.

### BACKGROUND

### (i) Technical Field

Embodiments described herein relate generally to an information processing device and a non-transitory computer readable medium.

### (ii) Related Art

JP-A-2004-172862 discloses an image composition method that enables image distribution while protecting privacy by determining a background region and an object region in a captured image, extracting the object region, and composing the object region with an optional background image.

JP-A-2005-055846 discloses a remote educational communication system that makes it possible to convey reactions of participants in an easy-to-understand manner by displaying avatar objects corresponding to all participants on screens of all the participants, distributing sensibilities felt by the participants as messages by simple operations, and dynamically adding motion as an image or a balloon-type modified display to an avatar object of each participant corresponding to the messages.

JP-A-2013-197740 discloses a technique that replaces a selected part of a face, a body, and a background included in a captured video with another video when the captured video is transmitted from an electronic device.

JP-A-2018-157321 discloses a video conferencing system in which only an image of a person is extracted from a captured image and transmitted to a counterpart.

JP-A-2019-149630 discloses a two-way video communication system in which a video of an operator is replaced with an avatar image.

Japanese Patent No. 5423068 discloses a conference terminal device that switches between using a camera image and using an avatar image depending on a size and a resolution of a displayable area of a display.

Japanese Patent No. 6563580 discloses a communication system that converts a video of a distributor into an avatar image and distributes the avatar image.

### SUMMARY

Aspects of non-limiting embodiments of the present disclosure relate to an information processing device and a non-transitory computer readable medium that, when a captured image is transmitted to an external device, can include an object to be included in the transmitted image while preventing the transmitted image from including an unintended object.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device includes: a memory; and a processor configured to, when a captured image to be transmitted includes an object that is not wanted to be included in transmitting the image to an external device, execute image processing such that an image of the object is not displayed.

### BRIEF DESCRIPTION OF THE DRAWINGS

Exemplary embodiment(s) of the present disclosure will be described in detail based on the following figures, wherein:

FIG. 1 is a diagram showing a system configuration of a video conferencing system according to an exemplary embodiment of the present disclosure;

FIG. 2 is a diagram showing an example of an image to be transmitted to a terminal device 10 of a counterpart when a video conference is conducted;

FIG. 3 is a diagram showing an image obtained by performing image processing of blurring a background image on the image shown in FIG. 2;

FIG. 4 is a block diagram showing a hardware configuration of the terminal device 10 according to the exemplary embodiment of the present disclosure;

FIG. 5 is a block diagram showing a functional configuration of the terminal device 10 according to the exemplary embodiment of the present disclosure;

FIG. 6 is a diagram showing an example of a do not display list stored in a data storage 33;

FIG. 7 is a diagram showing an example of a display permission list stored in the data storage 33;

FIG. 8 is a flowchart of an operation of the terminal device 10 according to the exemplary embodiment of the present disclosure;

FIG. 9 is a diagram showing an example of an image acquired by a controller 35 as the image to be transmitted to the terminal device 10 of a counterpart user of the video conference;

FIG. 10 is a diagram showing an example of a list of objects in an image that is generated based on the image to be transmitted;

FIG. 11 is a diagram showing how to compare the list of the objects in the image with the do not display list and determine whether there is a matching object;

FIG. 12 is a diagram showing an example of an image after performing image processing of preventing an image of a “television” that is determined not to be displayed from being displayed;

FIG. 13 is a diagram showing another example of an image after performing the image processing of preventing the image of the “television” that is determined not to be displayed from being displayed;

FIG. 14 is a diagram showing further another example of an image after performing the image processing of preventing the image of the “television” that is determined not to be displayed from being displayed; and

FIG. 15 is a diagram showing how to determine whether plural objects listed in the list of the objects in the image include an object not listed in the display permission list.

### DETAILED DESCRIPTION

Next, an exemplary embodiment of the present disclosure will be described with reference to the accompanying drawings.

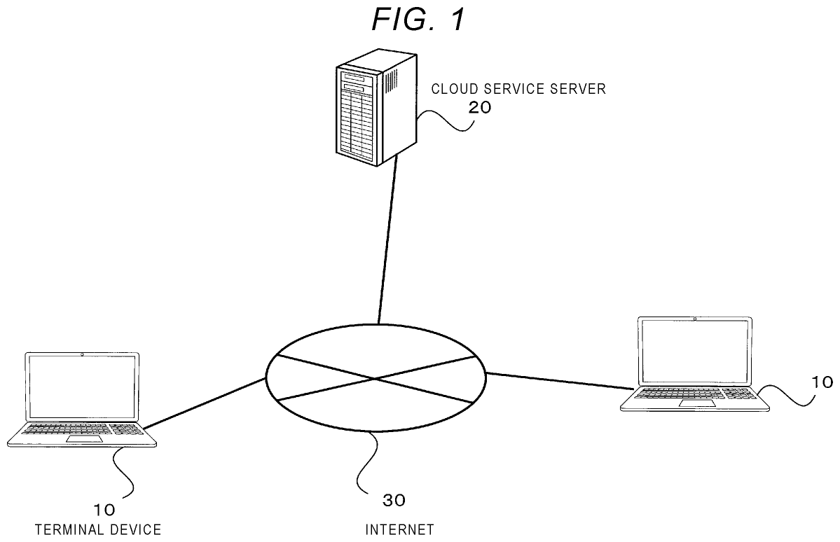

FIG. 1 is a diagram showing a system configuration of a video conferencing system according to an exemplary embodiment of the present disclosure.

In recent years, due to work style reforms, teleworking such as working at home, in which people work from home without going to an office, increases. In such teleworking, a user who performs the teleworking at home uses video conference to conduct a conference with a person working at an office and/or another teleworking user. The video conferencing system of the present exemplary embodiment is a system used to have such a video conference.

As shown in FIG. 1, the video conferencing system according to the exemplary embodiment of the present disclosure has a configuration in which plural terminal devices 10 such as personal computers are connected to each other via the Internet 30. A cloud service server 20 that provides a cloud service is connected to the Internet 30.

Here, the cloud service server 20 provides recognition processing of recognizing objects included in a moving image, as the cloud service. Specifically, the cloud service server 20 provides a service including (i) recognizing the objects included in the moving image transmitted from the terminal devices 10, for example, various objects such as a table, a sofa, a television, and a bookshelf, and (ii) returning a result of the recognition processing.

An application program (hereinafter abbreviated as an “application”) for conducting the video conference is installed in each of the terminal devices 10, and a user can use this application to conduct the video conference with other users at remote locations.

Specifically, when the application is started on the terminal device 10 and the video conference is started, an image is captured by a camera provided in the terminal device 10, audio information is acquired by a microphone, and the captured image and the acquired audio information are transmitted to the terminal device 10 of a counterpart user who conducts the video conference. Then, the terminal device 10 displays the image transmitted from the terminal device 10 of the counterpart of the video conference on a display, and outputs the transmitted audio information from a speaker.

With the video conferencing system of the present exemplary embodiment, the video conference can be conducted with other users at the remote locations in the above described manner. In recent years, the cameras mounted on the terminal devices 10 such as personal computers have high resolutions. When a video conference is conducted using a communication line capable of high-quality communication, a background image becomes clear, and an unnecessary object that a user does not want to display may be displayed.

For example, when a teleworking user working at home conducts the video conference as described above, a poster relating to a hobby, a photograph of a family member, a title of a book on a bookshelf, or the like may be displayed on the background. However, the user may not want other people such as a colleague at work, a boss at work, or an external business partner to know his/her personal information.

In such a case, in order to prevent the unnecessary object from being displayed on the background, there is a technique of identifying a background other than a person, and blurring the identified background or replacing the background image with another image.

However, if the background is always blurred or the background image is replaced with the other image, even when there is something that the user wants to show to the counterpart, the image is blurred or is replaced with the other image and is not displayed. For example, when the user wants to have a meeting using a video conference while showing a product, the product may not be displayed.

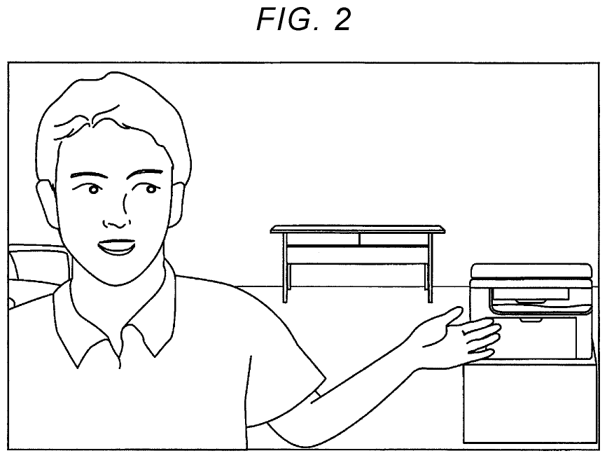

For example, FIG. 2 shows an example of an image to be transmitted to the terminal device 10 of the counterpart when the video conference is conducted. FIG. 2 shows an image example when a printer under development is shown and a meeting with another teleworking user is desired to be conducted.

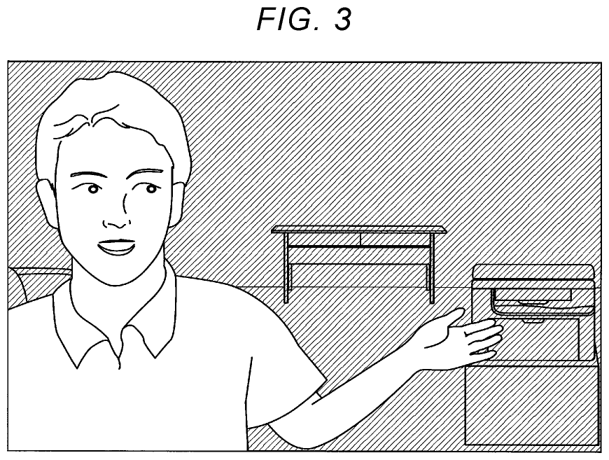

FIG. 3 shows an image obtained by performing processing of blurring the background image on the image shown in FIG. 2. In FIG. 3, diagonal lines represents the processing of blurring the image. With reference to FIG. 3, it can be seen that although the user wants to have the meeting with another teleworking user while showing the printer under development, if the processing of blurring all the background image other than the person is performed, the image of the printer that the user wants to show to the counterpart (that is, the other teleworking user) is blurred.

Therefore, the video conferencing system of the present exemplary embodiment performs processing as described below, so that when the captured image is transmitted to an external device, it is possible to include an object to be included in the transmitted image while preventing the transmitted image from including an unintended object.

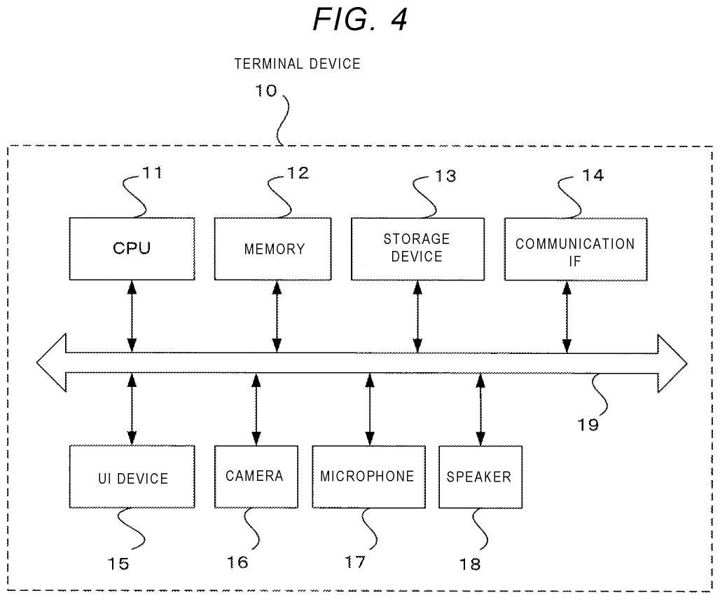

Next, FIG. 4 shows a hardware configuration of the terminal device 10 in the video conference system of the present exemplary embodiment.

As shown in FIG. 4, the terminal device 10 includes a CPU 11, a memory 12, a hard disk drive, a storage device 13 such as a solid state drive (SSD), a communication interface (which may be abbreviated as “IF”) 14 that transmits and receives data to and from an external device or the like via the Internet 30, a user interface (which may be abbreviated as “UI”) device 15 including a liquid crystal display and a keyboard, a camera 16, a microphone 17, and a speaker 18. These elements are connected to each other via a control bus 19.

The CPU 11 is a processor that executes predetermined processing based on a control program stored in the memory 12 or the storage device 13 to control an operation of the terminal device 10. In the present exemplary embodiment, the CPU 11 is described as one that reads and executes the control program stored in the memory 12 or the storage device 13. Alternatively, the program may be stored in a storage medium such as a CD-ROM and provided to the CPU 11.

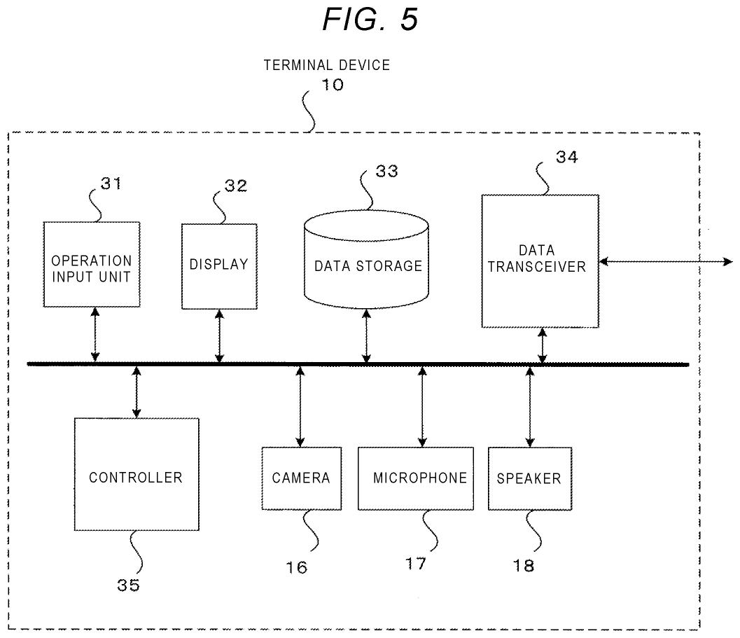

FIG. 5 is a block diagram showing a functional configuration of the terminal device 10 implemented by execution of the control program described above.

As shown in FIG. 5, the terminal device 10 of the present exemplary embodiment includes an operation input unit 31, a display 32, a data storage 33, a data transceiver 34, a controller 35, the camera 16, the microphone 17, and the speaker 18.

The operation input unit 31 inputs information on various operations performed by the user. The display 32 is controlled by the controller 35 and displays various information to the user. Specifically, the display 32 displays an image transmitted from the terminal device 10 of the counterpart of the video conference. The data storage 33 stores various data. The data transceiver 34 transmits and receives the data to and from the external devices such as the terminal devices 10.

The camera 16 is provided, for example, on an upper part of the display and serves as an image capturing unit that captures a user's face image when the video conference is conducted. The microphone 17 serves as a sound acquiring unit that acquires audio information emitted by the user when the video conference is conducted. The speaker 18 serves as an audio output unit that outputs an audio signal transmitted from the terminal device 10 of the counterpart of the video conference.

The controller 35 controls the operation of the entire terminal device 10. The controller 35 performs control such that when the video conference is conducted, a moving image captured by the camera 16 and the audio signal acquired by the microphone 17 are transmitted to the terminal device 10 of the counterpart user of the video conference, the moving image transmitted from the terminal device 10 of the counterpart user of the video conference is displayed on the display 32, and the transmitted audio signal is output from the speaker 18.

When an object that is not wanted to be included is included in an image to be transmitted in transmitting the moving image captured by the camera 16 to the terminal device 10 of the counterpart user of the video conference (which is the external device), the controller 35 executes image processing such that an image of the object is not displayed.

For example, the data storage 33 stores in advance a do not display list that is list information on objects that are not wanted to be included in the image to be transmitted. When the image to be transmitted includes any of the objects included in the do not display list, the controller 35 executes the image processing such that an image of the object is not displayed.

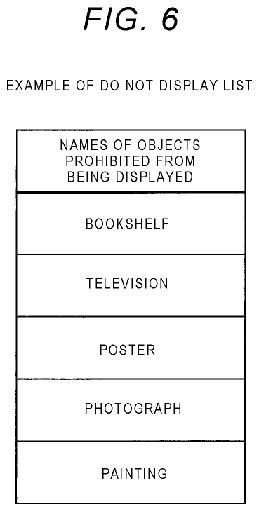

FIG. 6 shows an example of the do not display list stored in the data storage 33. In the do not display list shown in FIG. 6, objects having object names “bookshelf”, “television”, “poster”, “photograph”, and “painting” are specified as objects that are not wanted to be included in the image to be transmitted. It is noted that the user sets the do not display list in advance before conducting the video conference.

Instead of the do not display list, the data storage 33 may store a display permission list that is list information on objects that are permitted to be included in the image to be transmitted. In this case, when the image to be transmitted includes an object other than the objects included in the display permission list, the controller 35 executes image processing such that the image of the object is not displayed.

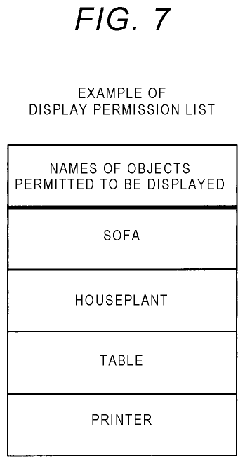

FIG. 7 shows an example of the display permission list stored in the data storage 33. In the display permission list shown in FIG. 7, objects having object names “sofa”, “houseplant”, “table”, and “printer” are specified as objects that are permitted to be included in the image to be transmitted. The user sets the display permission list in advance before conducting the video conference.

The present exemplary embodiment will be described using an example in which the names of the objects that are not wanted to be included in the image to be transmitted or the names of the objects that are permitted to be included in the image to be transmitted are designated by text in the do not display list or the display permission list. Alternatively, the do not display list or the display permission list may be generated using images of such objects.

When the image to be transmitted includes an object that is not wanted to be included, the controller 35 prevents an image of the object from being displayed by replacing the image of the object with a preset image.

Alternatively, when the image to be transmitted includes an object that is not wanted to be included, the controller 35 may prevent an image of the object from being displayed by filling the image of the object with a preset color.

Further alternatively, when the image to be transmitted includes an object that is not wanted to be included, the controller 35 may prevent an image of the object from being displayed by erasing the image of the object.

For example, when the image to be transmitted includes the object that is not wanted to be included, the controller 35 erases the image of the object by replacing the image of the object with a surrounding background image.

Next, the operation of the terminal device 10 according to the present exemplary embodiment will be described in detail with reference to the accompanying drawings.

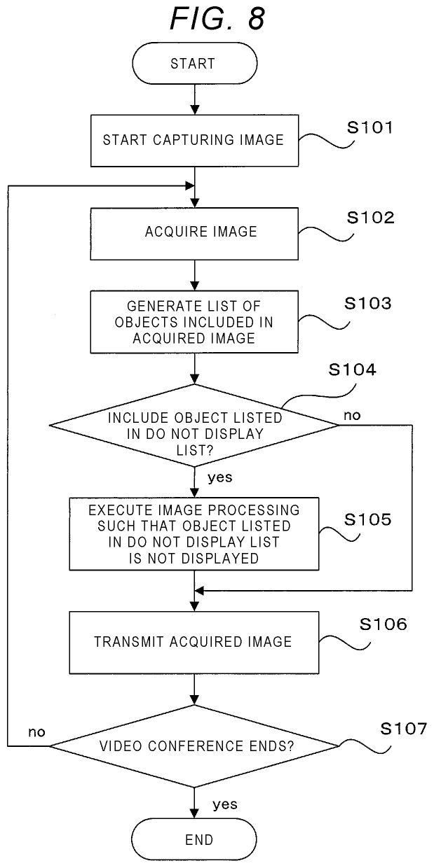

First, the operation of the terminal device 10 of the present exemplary embodiment will be described with reference to a flowchart of FIG. 8. With reference to this flowchart, an operation when the do not display list as shown in FIG. 6 is used will be described.

When the application of the video conference is started, the controller 35 starts capturing an image with the camera 16 in step S101.

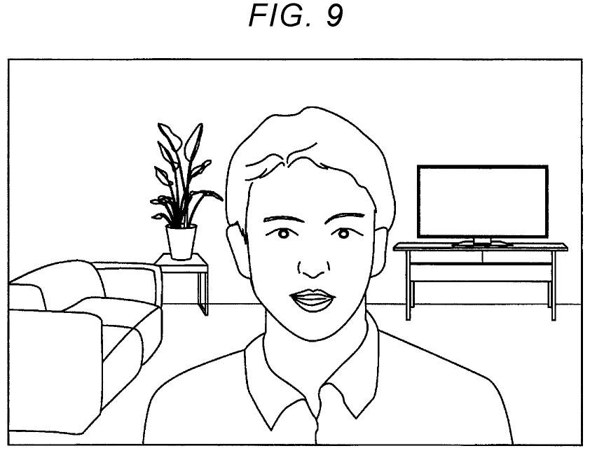

Then, in step S102, the controller 35 acquires an image to be transmitted to the terminal device 10 of the counterpart user of the video conference. FIG. 9 shows an example of the image acquired by the controller 35 in this manner.

With reference to FIG. 9, it can be seen that the image acquired by the controller 35 includes images of a sofa, a television, and a houseplant in the background, as well as an image of a user's face.

Then, when the controller 35 acquires such an image, the controller 35 generates a list of objects included in the acquired image in step S103.

Specifically, the controller 35 generates the list of the objects included in the acquired image by transmitting the image, which is to be transmitted to the terminal device 10 of the counterpart user of the video conference, to the cloud service server 20 via the Internet 30 and performing recognition processing of recognizing the objects in the image.

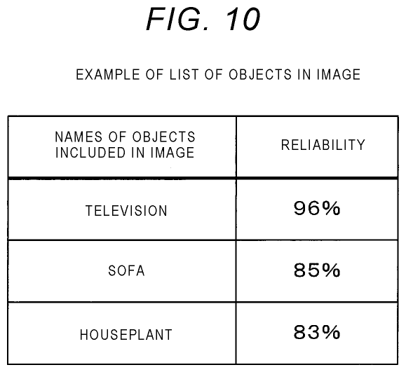

FIG. 10 shows an example of the list of the objects in the image generated in this way. With reference to FIG. 10, it can be seen that this list of objects includes (i) names of the objects included in the image and (ii) reliabilities of the objects in association with each other. The “reliability” indicates a degree of possibility that the object in interest is included in the image. The closer the reliability is to 100%, the higher the possibility that the object in interest is included in the image. In the example of the list of objects shown in FIG. 10, the reliabilities of the “television”, the “sofa”, and the “houseplant” are 96%, 85%, and 83%, respectively.

For example, the controller 35 determines that an object having a reliability of 80% or more is an object included in the image to be transmitted. That is, in the present exemplary embodiment, the controller 35 determines that the objects of the “television”, the “sofa”, and the “houseplant” are included in the image shown in FIG. 9.

If each of the terminal devices 10 has an image processing function of recognizing an object in an image, it is also possible to generate the list of the objects included in the acquired image without using the cloud service server 20.

Next, in step S104, the controller 35 determines whether the list of the objects included in the acquired image includes any of the objects listed in the do not display list.

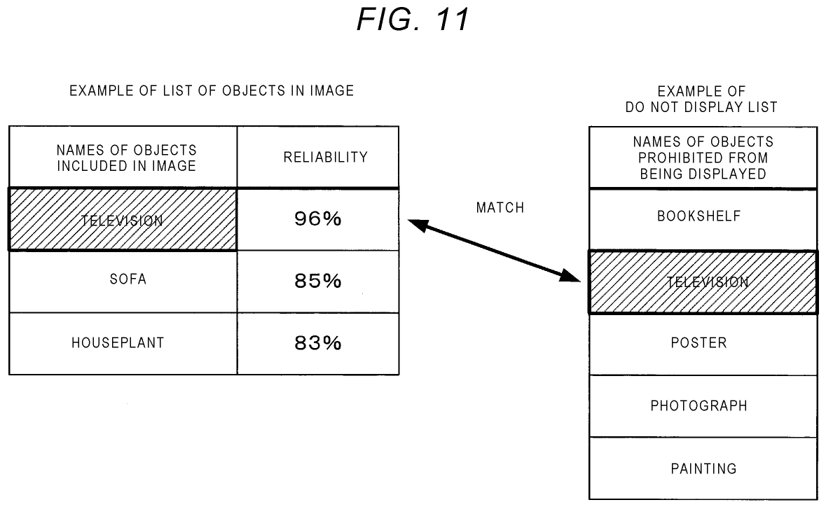

Specifically, the controller 35 compares the list of the objects included in the image shown in FIG. 10 with the do not display list shown in FIG. 6, to determine whether there is a matching object. In the example described above, as shown in FIG. 11, the “television” in the list of the objects in the image and the “television” in the do not display list match. Therefore, the controller 35 determines that the “television” is an object that is not to be displayed.

Then, when determining in step S104 that the list of the objects included in the acquired image includes any of the objects listed in the do not display list, the controller 35 executes the image processing in step S105 such that the object is not displayed.

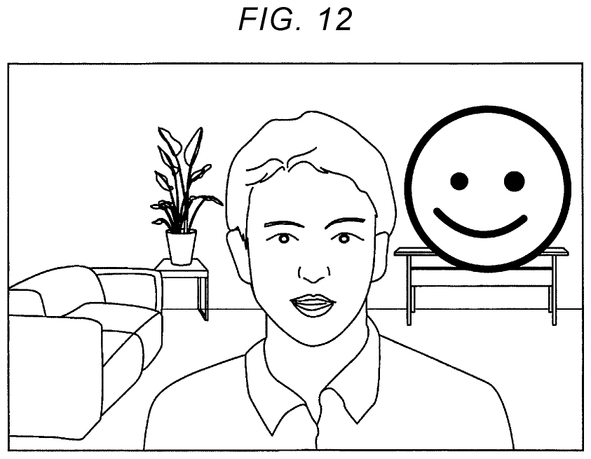

For example, as shown in FIG. 12, the controller 35 prevents the image of the “television” from being displayed by replacing the image of the “television” that is determined not to be displayed with another preset image.

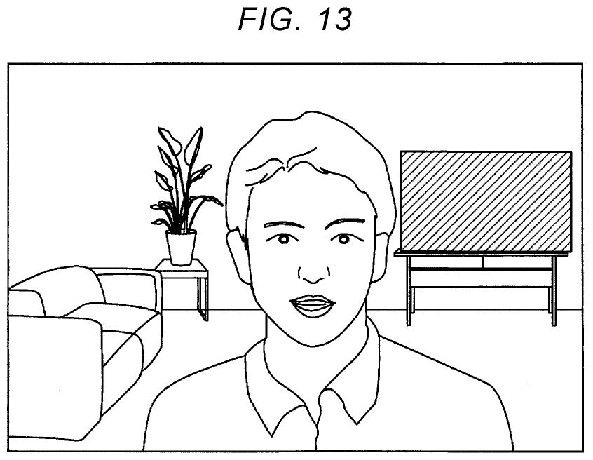

As shown in FIG. 13, the controller 35 prevents the image of the “television” from being displayed by replacing the image of the “television” that is determined not to be displayed with an image filled with the preset color. When the image is replaced with the image filled with the preset color in this way, if a shape of the image that is not to be displayed is filled directly, another use may be able to guess what image an original image is. Thus, a slightly wider area including the image that is not to be displayed is filled with the preset color.

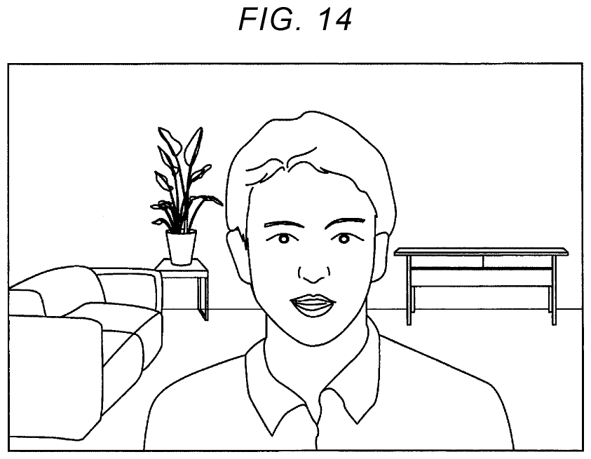

Alternatively, as shown in FIG. 14, the controller 35 may prevent the image of the “television” from being displayed by erasing the image of the “television” that is determined not to be displayed.

In the methods shown in FIGS. 12 and 13, the counterpart user of the video conference may know that something is hidden and is not displayed. On the contrary, when the image processing is executed such that no object originally exists there, it is possible to show to the counterpart user a state in which the image of the object is not included without giving a sense of discomfort to the counterpart user.

Examples of the method of erasing an image include a method of erasing the image of the object by replacing the image of the object with the surrounding background image. Specifically, an image in which the “television” does not exist may be generated by replacing the image of the “television” with a pattern, a color, and the like of a wallpaper around the “television” to be erased.

Then, in step S106, the controller 35 transmits the image subjected to the image processing described above, to the terminal device 10 of the counterpart user of the video conference.

Then, the controller 35 determines whether the video conference ends in step S107. When the video conference does not end, the processing of steps S102 to S106 is repeated.

When the controller 35 determines in step S104 that the list of the objects included in the acquired image includes none of the objects listed in the do not display list, the controller 35 transmits the acquired image directly in step S106.

Described above is the example in which the do not display list as shown in FIG. 6 is used to prevent the image to be transmitted from including the object that is not wanted to be included. However, even when the display permission list as shown in FIG. 7 is used, it is also possible to prevent the image to be transmitted from including the object that is not wanted to be included. It is noted that, in this case, it is necessary to list all objects that are permitted to be included in the image to be transmitted in the display permission list.

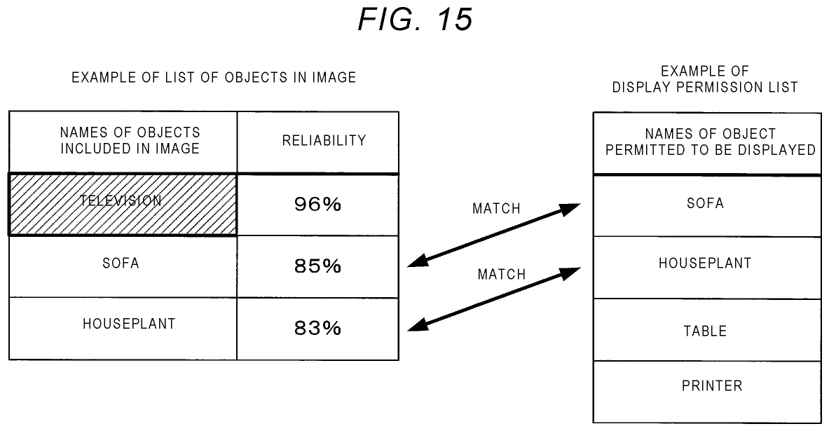

When the display permission list is used in this way, as shown in FIG. 15, the controller 35 determines whether plural objects listed in the list of the objects in the image include an object that is not listed in the display permission list. In the example shown in FIG. 15, among the “television”, the “sofa”, and the “houseplant” included in the image, the “sofa” and the “houseplant” are listed in the display permission list, but the “television” is not listed.

Therefore, the controller 35 determines that the “television” is an object that it not to be displayed in the image to be transmitted. An image processing method for preventing the image of the object that is determined to be the object not to be displayed from being displayed in the image is the same as the method described above.

In the above exemplary embodiment, described is the example in which a specific object is prevented from being included in the image transmitted to the counterpart user when the video conference is conducted. It is noted that the present disclosure is not limited to the video conference. The present disclosure is applicable to a case of transmitting a captured image to a device at a remote location, in a similar manner.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Modification

In the above exemplary embodiment, described is the example in which the terminal device 10 is a personal computer. It is noted that the present disclosure is not limited to this example. The present disclosure is applicable even to a case in which the video conference is conducted using another information processing device such as a smartphone or a tablet terminal device, in a similar manner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a memory; and
a processor configured to, when a captured image to be transmitted includes an object that is not wanted to be included in transmitting the image to an external device, execute image processing such that an image of the object is not displayed.

2. The information processing device according to claim 1, wherein
the memory stores in advance list information on objects that are not wanted to be included in the image to be transmitted, and
the processor is configured to, when the image to be transmitted includes any of the objects included in the list information, execute the image processing such that the image of the object is not displayed.

3. The information processing device according to claim 1, wherein
the memory stores in advance list information on objects that are permitted to be included in the image to be transmitted, and
the processor is configured to, when the image to be transmitted includes an object other than the objects included in the list information, execute the image processing such that the image of the object other than the objects included in the list information is not displayed.

4. The information processing device according to claim 1, wherein the processor is configured to, when the image to be transmitted includes the object which is not wanted to be included, prevent the image of the object which is not wanted to be included from being displayed by replacing the image of the object which is not wanted to be included with a preset image.

5. The information processing device according to claim 1, wherein the processor is configured to, when the image to be transmitted includes the object which is not wanted to be included, prevent the image of the object which is not wanted to be included from being displayed by filling the image of the object which is not wanted to be included with a preset color.

6. The information processing device according to claim 1, wherein the processor is configured to, when the image to be transmitted includes the object that is not wanted to be included, prevent the image of the object which is not wanted to be included from being displayed by erasing the image of the object which is not wanted to be included.

7. The information processing device according to claim 6, wherein the processor is configured to, when the image to be transmitted includes the object which is not wanted to be included, erase the image of the object which is not wanted to be included by replacing the image of the object which is not wanted to be included with a surrounding background image.

8. A non-transitory computer readable medium storing a program that causes a computer to execute information processing, the information processing comprising:
when a captured image to be transmitted includes an object that is not wanted to be included in transmitting the image to an external device, executing image processing such that an image of the object is not displayed; and
transmitting the image subjected to the image processing to the external device.

9. An information processing device comprising:
a memory; and
processing means for, when a captured image to be transmitted includes an object that is not wanted to be included in transmitting the image to an external device, executing image processing such that an image of the object is not displayed.
